(19) United States
(12) Patent Application Publication
(10) Pub. No.: US 2015/0239558 A1
(43) Pub. Date: Aug. 27, 2015

(54) DELIVERING FLUIDS OR GRANULAR SUBSTANCES BY PROJECTING SHELLED PORTIONS THEREOF

(71) Applicants: Shlomo ALKAHER, Haifa (IL); Yoram ILAN-LIPOVSKY, Tel-Aviv (IL)

(72) Inventors: Shlomo ALKAHER, Haifa (IL); Yoram ILAN-LIPOVSKY, Tel-Aviv (IL)

(73) Assignee: ELBIT SYSTEMS LTD.., Haifa (IL)

(21) Appl. No.: 13/569,589

(22) Filed: Aug. 8, 2012

Related U.S. Application Data
(60) Provisional application No. 61/522,693, filed on Aug. 12, 2011.

(51) Int. Cl. B64D 1/16

(52) U.S. Cl. CPC B64D 1/16

(57) ABSTRACT

A method of delivering over the air, shelled portions of fluids or granular substances containing effective ingredients, to a target, is provided herein. The method includes the following stages: selecting a type and a size of the shelled portions containing the required effective ingredients, based on mission parameters and physical data of a scene containing the target; conveying the shelled portions to a delivery point, based on the mission parameters and the physical data; and ballistically delivering the shelled portions towards the target, wherein the shelled portions comprise fluids or granular substances covered by shells that provide the shelled portions a ballistic coefficient that is significantly higher than a ballistic coefficient of similar portions without the shells.

### CROSS REFERENCE TO RELATED APPLICATIONS

This application is a non-provisional patent application claiming priority from U.S. provisional patent application No. 61/522,693 filed on Aug. 12, 2011, the content of which is incorporated herein by reference in its entirety.

### BACKGROUND

1. Technical Field

The present invention relates to the field of delivery of fluids and other materials over the air, and more particularly, to a remote ballistic delivery of fluids using aerial vehicles.

2. Discussion of Related Art

Aerial vehicles are used today in various missions of delivery of fluids and granular substances from the air. In some cases, delivery from the air is the only option either due to limited access or because of the effectiveness of the air delivery in covering large areas in a short time. Non-limiting examples for such mission include firefighting, fertilizing, cooling nuclear reactors as well as using herbicides and pesticides.

The main challenge in delivering fluids and granular substances, due to their particle nature, is the tendency of these materials to be greatly affected by air resistance. Specifically, large portions of the fluids transform into an aerosol which drifts by the wind and never reaches the target on the ground or above it. The aerosol may also affect the aerial vehicle or people on board it or on the ground. In a case that the fluid contains harmful ingredients, the aerosol or other buoyant particles can cause health problems or harm the aerial vehicle. Solid granular substances suffer from similar limitations and while they do not transform into aerosol their air resistance is sufficiently high so they lose their ballistic characteristics.

In order to avoid the aforementioned aerosol effect, aerial flights today are performed at low altitudes (less than 100 feet above ground). Such a flight profile is very risky, requires special aircrafts and special pilot skills. Because of those high requirements, current aerial missions can be performed nowadays only at day time and they are stopped altogether during the night, or in strong wind and low visibility conditions such as smoke, fog or dust.

FIG. 1 is a schematic illustration of an aerial vehicle 10 discharging fluid 40 from the air towards targets 20 such as trees on the ground 30. Due to the aforementioned air resistance, some portions 50 of the fluid are cut from the main bulk of fluid 40 while other portions of fluid 40 transform into aerosol 60. As the aerosol loses its ballistic character it becomes very difficult, if not impossible to deliver effective amounts of fluid 40 to ground 30 or targets 20. It is noted that the aforementioned problem becomes ever more challenging when air vehicle 10 is located higher up in the sky.

### BRIEF SUMMARY

One aspect of the present invention provides a method of delivering over the air, shelled portions of fluids or granular substances containing effective ingredients to a target. The method includes the following stages: . . . selecting a type and a size of the shelled portions containing the required effective ingredients, based on mission parameters and physical data of a scene containing the target; conveying the shelled portions to a delivery point, based on the mission parameters and the physical data; and ballistically delivering the shelled portions towards the target, wherein the shelled portions comprise fluids or granular substances covered by shells that provide the portions a ballistic coefficient that is significantly higher than a ballistic coefficient of similar portions without the shells. The mission parameters may include any of the following: the required type of effective ingredients, the height of the target above sea level, the required height above the target above ground level (AGL), the required velocity of the aerial vehicle, the footprint and the distribution at the target, and meteorological effects such as wind velocity and direction around the aerial vehicle at the delivery point and/or the wind velocity and direction around the target.

Advantageously, embodiments of the present invention provide a solution to the aforementioned risky flight profile in order to address the aerosol effect. Embodiments of the present invention ensure safe flight in high altitude for common commercial transport airplanes and further enable to perform the mission at day or at night and in all weather conditions.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic diagram showing fluid delivery from the air according to the existing art;

FIG. 2 is a schematic diagram showing fluid and granular substances delivery from the air according to some embodiments of the present invention;

FIG. 3 show cross-sectional views of several non-limiting examples for the shelled portions of the fluid or the granular substance according to some embodiments of the present invention;

FIG. 4 is a schematic diagram illustrating one aspect according to some embodiments of the present invention;

FIG. 5 is a schematic diagram illustrating one aspect according to some embodiments of the present invention;

FIG. 6 is a high level flowchart illustrating a method according to some embodiments of the present invention;

FIG. 7 is a schematic diagram showing an exemplary embodiment of an airborne dispenser of the shelled portions of fluids and granular substances in accordance with some embodiments of the present invention;

FIG. 8 is a schematic diagram showing an exemplary application of some embodiments of the present invention;

FIG. 9 is a schematic drawing illustrating yet another embodiment of the shelled portion in accordance with embodiments of the present invention;

FIG. 10 is a schematic drawing illustrating an aerial vehicle equipped with a dispenser in accordance with embodiments of the present invention; and

FIG. 11 is a schematic drawing illustrating a surface vehicle equipped with a dispenser in accordance with embodiments of the present invention.

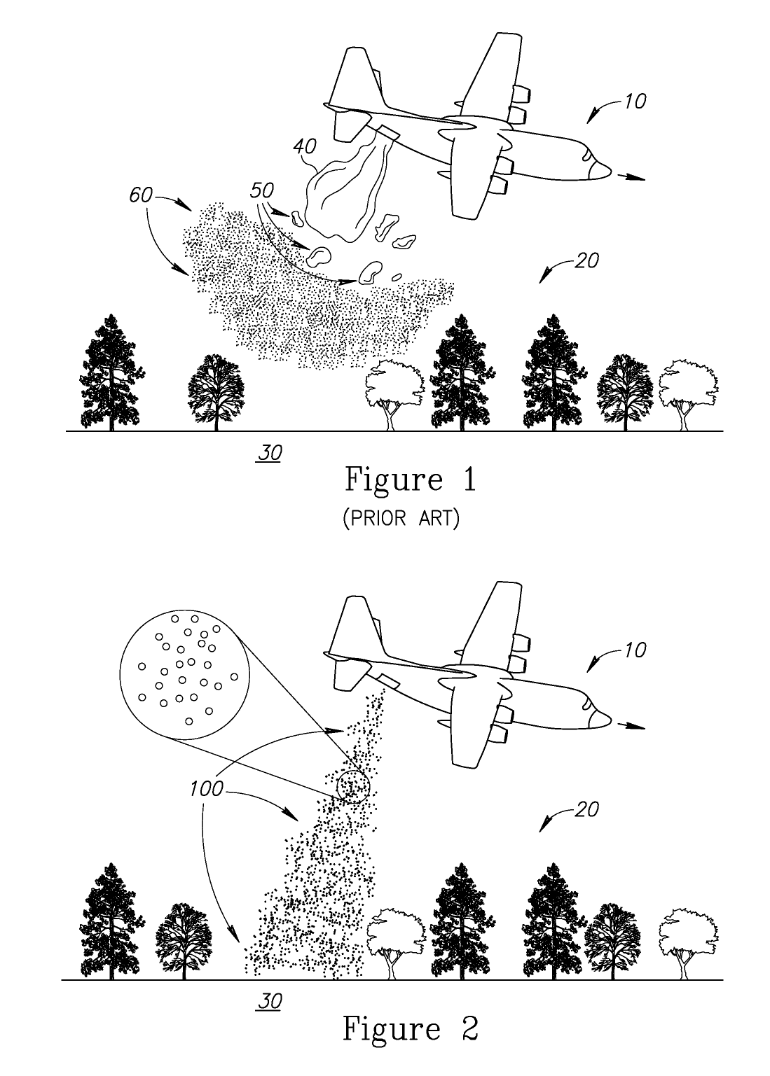

### DETAILED DESCRIPTION

Prior to setting forth the detailed description, it may be helpful to set forth definitions of certain terms that will be used hereinafter.

The term “shelled portions” as used herein refers to portions of the effective substance, either in the form of a fluid, powder or granules that are packed by a shell, preferably but not necessarily a flexible shell that is characterised by a ballistic coefficient that is significantly higher than the ballistic coefficient of similar portions of the effective substance or any other material which are not packed by the shells. The shelled portioned are manufactured so that they resemble in size, shape and weight so as to preserve ballistic properties of the shelled portions which contribute to the repeatability of the aerial delivery of theses shelled portions. These shelled portions may weigh each approximately 100 to 300 grams. The restrictions on the weight stem from the fact that proposed shelled portions should not be lethal upon impact with humans or animals. Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 2 is a schematic illustration of an aerial vehicle 10 discharging loads of shelled portions 100 of either fluids or granular substances from the air towards targets 20 such as trees on the ground 30. As shown, the shelled portions 100 are selected to be of a size that is sufficient to maintain their ballistic character. The actual size of theses shelled portions is very much a function of the height from which these shelled portions are projected, the weather conditions, and the purpose of the delivery of the fluid or granular substance. It is understood that diameter of 0.5 cm may be reasonable for low altitude missions (tens of meters) whereas shelled portions having a diameter of several centimeters will be required for higher altitudes (over 100 meter). It is noted that the aforementioned values are for demonstrative purposes only and should not be regarded as limiting the invention.

Consistent with some embodiments of the present invention, the shelled portions of effective ingredients are selected on a per-mission basis to have the size, weight and packaging material so that they are non-harmful upon impact with human beings or any objects at the target are, whenever avoiding harmful impact is a consideration. Put differently, both the selection of the shelled portion and the ballistic delivering of the shelled portions are carried out in view of avoiding harmful impact of the shelled portion in a case of human presence or any object presence near or at the target.

In order to protect the environment, the materials of the shells may be selected such that they do not pollute the ground or the air upon falling and breaking at the target.

Consistent with some embodiments of the present invention, the shelled portions are designed such that a dissemination effect of the liquid or granular substance is achieved by tearing, opening, or breaking of the shells upon hitting the target or object above the target.

The contents of the shelled portion may be determined and selected on an ad hoc basis. For fire fighting, a fire extinguishing material may be used. Pesticides, herbicides and fertilizers may be used in agricultural applications. The shell should merely keep the fluid or granular substance in a shape, possibly made of a flexible material, usually but not necessarily a sphere.

In accordance with some embodiments of the invention, the shells of the shelled portions 100 may be made of bio degradable materials, possibly compostable materials. By selecting the shells to be compostable materials, the shells are able to break down into carbon dioxide, water and biomass once reaching the target. Advantageously, shells made of compostable materials, may not produce any toxic material and very much like compost should be able to support plant life. In some embodiments, the shells may be made from plant materials such as corn, potato, cellulose, soy and sugar. In some embodiments, the shells are made of materials that break down possibly but not exclusively through the action of a naturally occurring microorganism over a period of several weeks—a period that is substantially shorter than the decomposing period of compostable materials.

It is however understood that other materials which are not compostable may be also used for shells, including but not limited to, polyester and the like. In some embodiments, the selection of the material for the shells is selected so that in the decomposing or breaking down process, or burning on a fire, neither toxic gases nor toxic fumes are released. The decomposing process may occur on the ground and may be accelerated by bacteria on the ground.

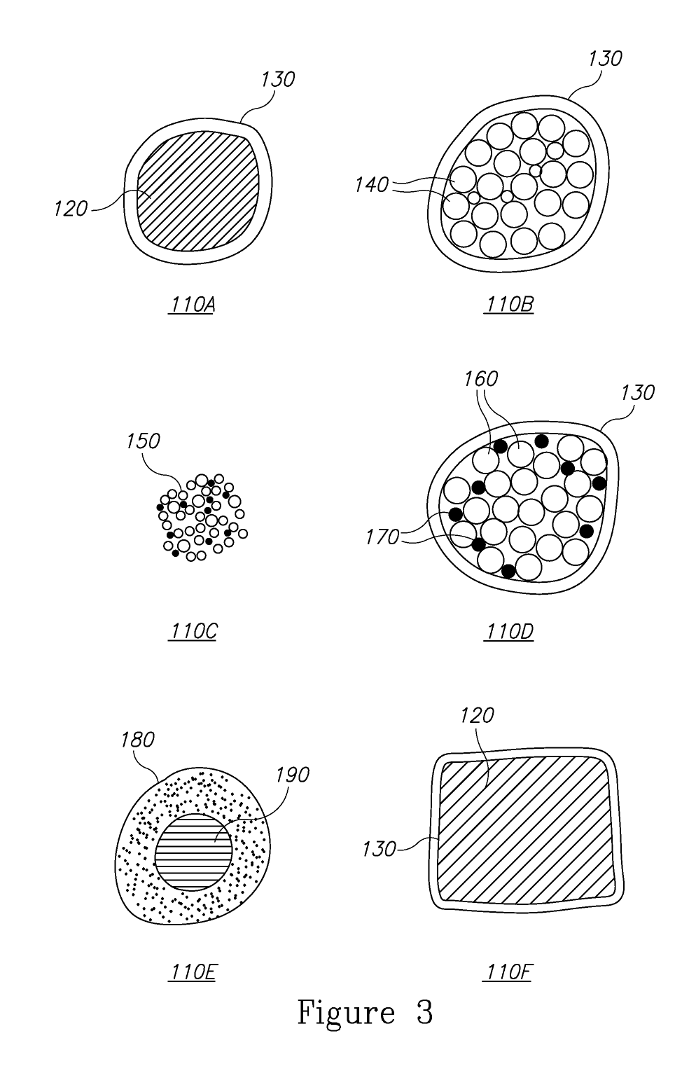

FIG. 3 show cross-sectional views of several non-limiting examples for the shelled portions of the fluid or the granular substance according to some embodiments of the present invention. Shelled portion 110A includes a shell 130 and a homogenous fluid 120 that can be selected in accordance with the desired effect at the target. Shelled portion 110B includes a shell 130 and a granular substance 140 that can be either solid or frozen fluid or ice slurry. In a case of frozen fluid, the shelled portion 11B may be used to cool down the target on top of other effects. For example, iced granular substance may be tightly packed within a shell and be used to cool a nuclear reactor on the ground. Portion 110C may contain a portion (with or without a shell) of granular substance pressed together. Two or more ingredients may be used in combination so that a different effect is achieved at the target (e.g., due to mixing) or prior to hitting the target due to rotational forces. Additionally, at least one of the substances in the packed shell may be arranged to generate a gaseous substance or foam upon impact at target

Consistent with some embodiments, shelled portion 110D includes a shell 130 and a first granular substance 160 put together with a second granular substance 170 both can be either solid or frozen fluid. In one embodiment, first granular substance 160 may inflate or generate a gaseous substance at the target thus facilitating the propagation of second granular substance 170.

Consistent with some embodiments, shelled portion 110E includes a shell 180 that may be in the form of a frozen fluid and another fluid or granular substance 190 contained within. The shell may be made by an environmental friendly material that disintegrates or evaporated at the target. The shell may also be selected for timed application of the effective ingredient at the target, for example by selecting a material for the shell that disintegrated after a predefined time and only then fluid or granular substance 190 is applied to the target. The shell may also be configured to break or open while still in the air prior to the impact with the target so that release of the effective ingredients starts well before the impact so that is some cases the impact is with an empty or nearly empty shell. Consistent with some embodiments, shelled portion 110F includes a shell 130 and fluid or granular substance 120 wherein the shell is shaped as a cube or a prism so that packaging is easier at the expenses of air resistance.

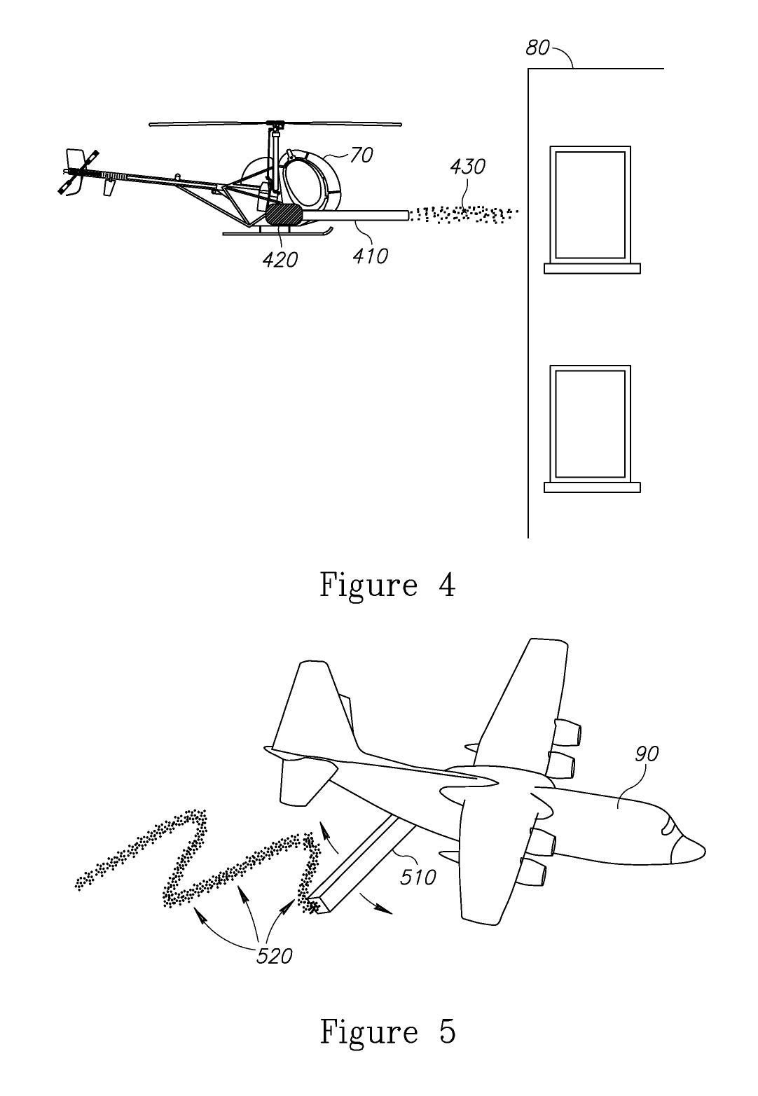

FIG. 4 is a schematic diagram illustrating one aspect according to some embodiments of the present invention. An aerial vehicle 70 is shown delivering a load of shelled portions 430 in an upward forward direction towards a target 80. Shelled portions 430 are stored as a payload 420 on aerial vehicle 70 and delivered via a tube 430. It is well understood that shelled portions 430 need not necessarily be delivered from an aerial vehicle as long as they are delivered from a certain height and over the air (e.g., from a tower or from a tube on the ground using pressure).

When dropped on burned trees or vegetation in a wildfire, the shell may break up or being opened up at about 30 feet above the flames and dispense the fluid or granular substance in the shells evenly on the target.

FIG. 5 is a schematic diagram illustrating one aspect according to some embodiments of the present invention. An aerial vehicle 90 is shown delivering a load of shelled portions 520 using a sleeve 510 configure to move at any direction in order to control the coverage area of load of shelled portions 520. It is understood that various other methods of discharging shelled portions 520 may be used.

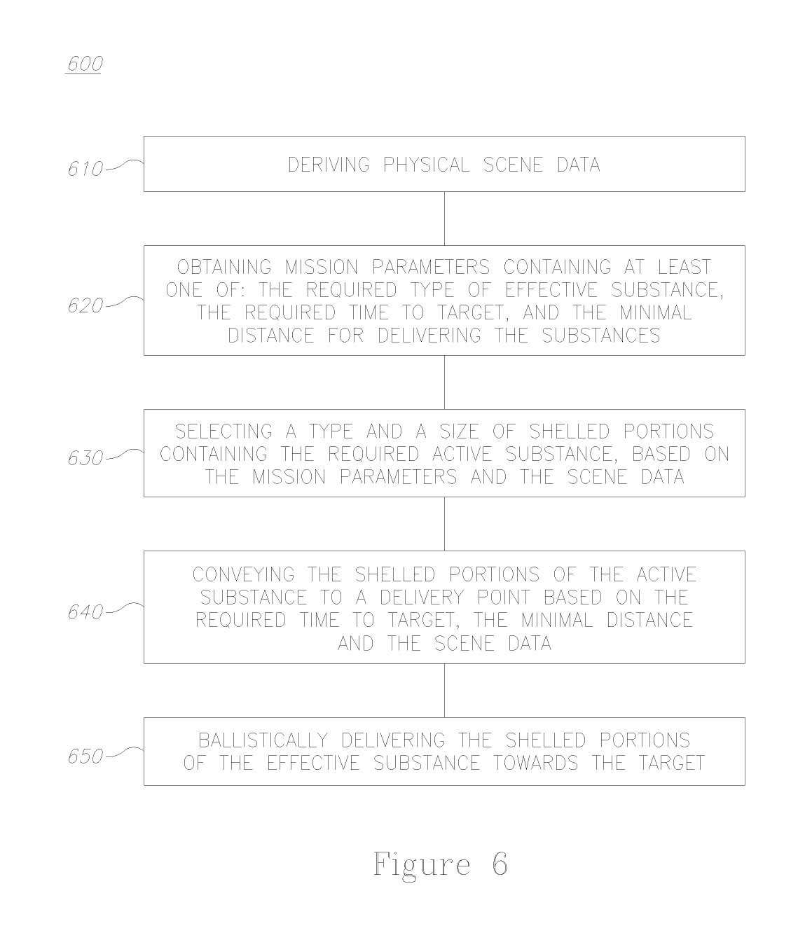

FIG. 6 is a high level flowchart illustrating a method according to some embodiments of the present invention. Method 600 takes advantages of the aforementioned shelled portions of various shapes, sizes, and contents and describes a generalized procedure that enables to tailor the specific shelled portions of substance to the requirements of a specific mission and further based on physical attributes of the scene over the target. Any mission of delivery from the air of fluids or granular substance may impose different restrictions such as the optimal location for the point of delivery, timing considerations as well as safety constraints. Thus, method 600 may start up with the stage of deriving physical scene data 610. The physical scene data may be derived from many sources and types of data such as optical, thermal, electromagnetic, and the like. The method may go on to the stage of obtaining the mission parameters 620, possibly from a user who plans the mission. These parameters may include, for example: the required type of effective ingredients, the required density of the effective substance at the target, the elevation over target, the required time to target, and sometimes minimal distance for delivering the substances possibly due to safety reasons. Then, the method goes on to the stage of selecting 620 a type and a size of shelled portions containing the required effective ingredients, based on the mission parameters. The method then goes on to the stage of conveying 630 the shelled portions of the effective substance to a delivery point, based on the required time to target and the minimal distance. In a case of delivery using an aerial vehicle the delivery point is where the aerial vehicle discharges the shelled portions. Finally, the shelled portions are ballistically delivered 640 towards the target.

As will be appreciated by one skilled in the art, some of the steps of method 600 may be embodied as a computer implemented method or computer program product. Accordingly, aspects of some of the steps of method 600 may take the form of an entirely hardware embodiment, an entirely software embodiment (including firmware, resident software, micro-code, etc.) or an embodiment combining software and hardware.

The delivery may be in such a way that yields a specified footprint at impact height over the target. The delivery may be carried out in various dispensing manners that are selected as to density and form of distribution of the shelled portions. The footprint is thus an effective metric by which the type of delivery may be carried out.

It is understood that the stage of ballistically delivering the shelled portions is carried out naturally once the physical conditions, specifically the size of the shelled portions, are met. It is further understood that by carefully planning the mission and selecting the appropriate type of shelled portions, the specified targets may be reached in the required timing and the required amount of the effective ingredients. The selecting and the planning may be optimized in accordance with the existing variety of the shelled portions and further by optimization methods known in the art in different fields.

In accordance with embodiments of the present invention, the footprint of the shelled portions at the target is controllable and can be planned on a per mission basis. This is due to the repeatability of delivery of the shelled portions, achieved, as explained above by the high ballistic coefficient of the shelled portions. In order to achieve this end, the shelled portions may be homogenous in size, shape and weight. This homogeneity results in a similar ballistic behavior for all shelled portions of a common type. Then, in operation, by selecting mission parameters such as the height and speed of the aerial vehicle at the delivery point, the footprint of the shelled portions at the target can be planned and predicted.

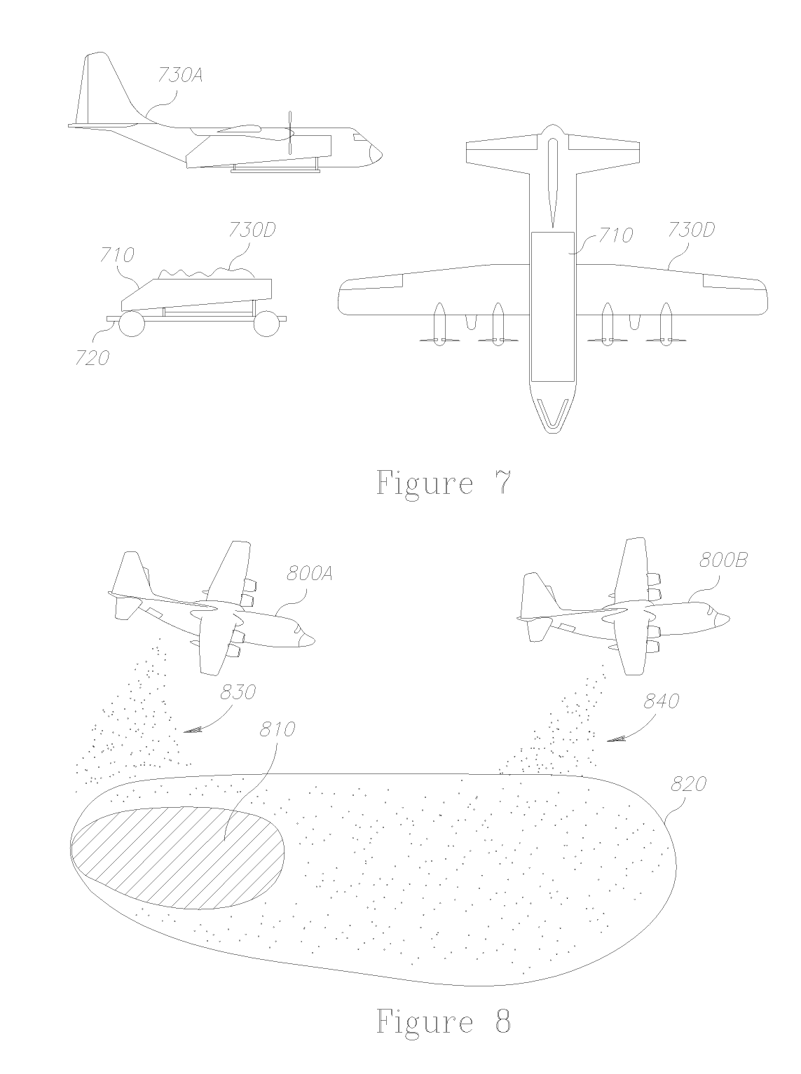

FIG. 7 is a schematic diagram showing an exemplary embodiment of an airborne dispenser of the shelled portions of fluids and granular substances in accordance with some embodiments of the present invention. Airborne dispenser 710 is shown on a carriage 720 and further in a cross section within an airplane 730A and in a top view of an airplane 730B. As illustrated, carriage 720 enables the easy loading of dispenser 710 into any aerial vehicle without further adjustments. Dispenser 710 is shaped and configured to be inserted, possibly in modular sections 720 so that the volume of the shelled portions is tailored to the planned mission as well as the carrying capacity of the aerial vehicle. In some embodiments Dispenser 720 may be entered in a matter of few minutes to any standard aircraft and thus convert the standard aircraft into an aircraft that is capable for ballistic delivery of the shelled portions. In order to preserve current delivery methods, dispenser 710 may be configured for dual use so that in one configuration the dispenser is operable to carry on fluids and deliver them in the traditional manner and in another configuration the dispenser is configured to deliver the shelled portions of the present invention.

Additionally, in some embodiments of the present invention, modular sections 720 of dispenser 710 may each contain a different type of shelled portions. Dispenser 710 may be further configured to dispense on a single mission, a plurality of types of shelled portions 100 so that the selection of the types of shells and the effective substance or fluid may be selected on the fly ad so may be the aforementioned stages of method 600 discussed above. This feature may further enhance flexibility of the embodiments of the present invention.

FIG. 8 is a schematic diagram showing an exemplary application of some embodiments of the present invention. The diagram shows a dynamic target on the ground which includes a first portion 810 and a second portion 820. First portion 810 may be a target of a first kind (such as active fire or an oil spill in the ocean) and a second portion 820 may be a target of a second kind (such as area soon to be caught by the fire or soon to be contaminated by the oil spill, respectively). In some embodiments of the present invention, it would be possible to tailor the appropriate type of shells and effective substance, to the different types of target as illustrated above, respectively while on a single mission (shelled portions of type 830 are used for target 810 when airplane is in location 800A while shelled portions of type 840 are used for target 820 when airplane is in location 800B. This feature is particularly advantageous when handling a dynamic target being a target that changes it size and its nature over a period of time of the order of a single mission. For example, fire fighting material may be used on the area already caught by fire 810 while fire retardants may be used on an area not yet caught by fire 820.

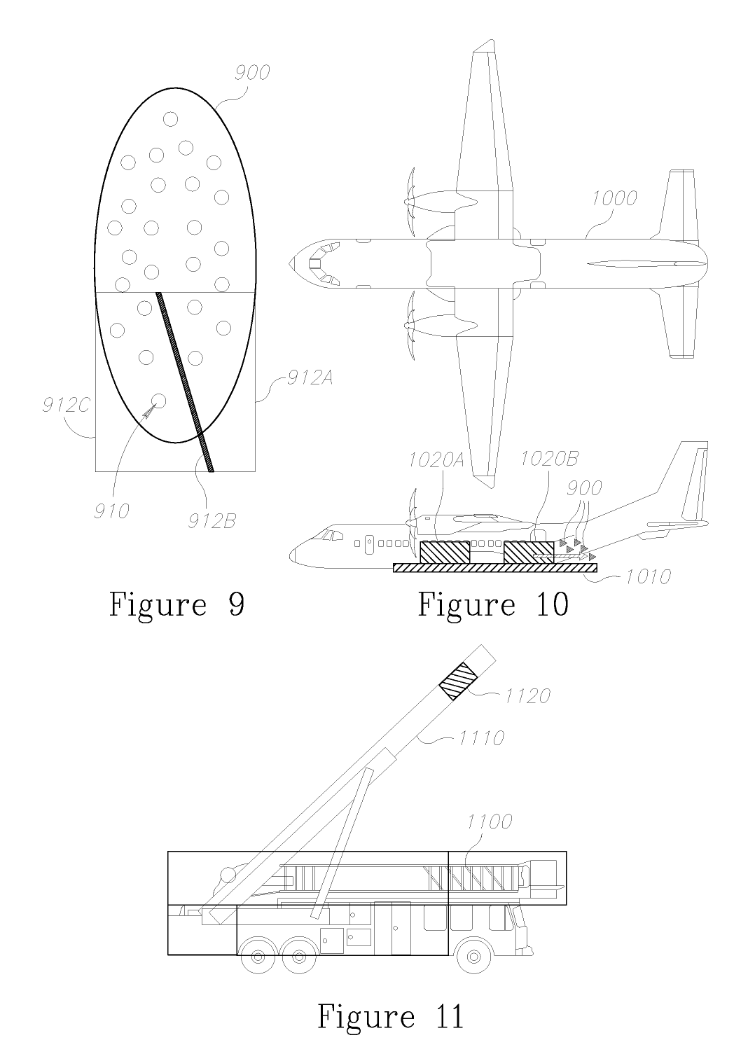

FIG. 9 is a schematic drawing illustrating yet another example of the shelled portion in accordance with some embodiments of the present invention. Shelled portion (or pellet) 900 is shown here in the shape of a hollow ellipsoid whose shell is punctured with holes such as hole 910. Pellet 900 further includes several fins 912A-912C located on one end of pellet wherein each one of the fins is slightly tilted along the longitudinal axis of pellet 900 (the tilt angle is exaggerated in the figure for illustrative purposes). Pellets such as pellet 900 may be effectively and easily filled with fluid by grouping together many pellets and submerging them in a container (e.g., within the dispenser apparatus) filled with the fluid containing the effective substance. The fluid then enters through the holes. By selecting the holes to be small enough (depending also on the properties of the fluid) dripping of the fluid is substantially avoided when the pellet is in static position. In operation, pellets are ballistically discharged from the dispenser into the air. Due to gravity forces and fins 912A-912C, pellet 900 starts rotating around its longitudinal axis in an increasing angular speed. Beyond a specific threshold of the angular speed (which can be determined, for example, by the viscosity of the fluid and the size of the holes), the fluid starts exiting or so-called being sprinkled out of pellet 900 until pellet 900 is completely emptied. Pellet 900 can be designed (e.g., size of holes, tilt angle of fins, amount and type of fluid, and the like) in combination with the delivery parameters (e.g., height over target, vehicle velocity and the like) so that pellet 900 is completely emptied prior to impact with the target so as to minimize the hit at the target.

FIG. 10 is a schematic drawing illustrating an aerial vehicle equipped with a dispenser in accordance with some embodiments of the present invention. Aerial vehicle 1000 can accommodate on its bottom side, approximately near the wings, a conveyer 1010 positioned along its longitudinal axis. A container 1020 can move freely along conveyer 1010. In order to discharge the aforementioned pellets or other shelled portions discussed herein, container 1020 is being accelerated along conveyer 1010 from position 1020A to position 1020B where the container is brought to a sudden and complete stop. A door in the container is then opened and the shelled portions, or pellets, are forced ballistically out of the container.

FIG. 11 is a schematic drawing illustrating a surface vehicle equipped with a dispenser in accordance with some embodiments of the present invention. Similar to the dispenser described above in regards with the aerial vehicle, the dispenser of surface vehicle 1100 includes a conveyer 1110 that may be tilted to reach a specified angle, and a container 1120 that may be moved forward slowly and then brought to a complete and sudden stop. Conveyer 1010 should be sufficiently long so as to enable a minimal acceleration force applied to container 1020 so as not to affect the shells of the pellets. The exact length of conveyer 1010 is determined based on the pellet properties such as the strength of the shell and the size and number of the holes on it. The shelled portions are thus projected from container 1120 with both vertical and horizontal velocities that are selected based on the mission and the location of the target.

By mere way of example, it is understood that many missions may be carried out utilizing embodiments of the present invention. In one embodiment, the mission may be cooling down of nuclear reactors. In such a mission there is significant safety distance. Granular ice may be then used for the cooling. In another embodiment, the mission may be riot control in which the shelled portion may contain non-lethal stinky substance, tear causing substance and the like. In fire fighting, two types may be used as explained above (fire fighting and fire retardant). Similarly, in handling oil spills, one material may be used to dissolve the oil while another substance may be used to hedge the oils spill and reduce its spreading. Many more applications may benefit from advantages of the embodiments of the present invention.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1-28. (canceled)

29. A computer implemented method of delivering over the air, shelled portions of fluids or granular substances containing effective ingredients, to a target, the method comprising:
selecting shelled portions parameters comprising a type and a size of the shelled portions containing the required effective ingredients, based on mission parameters and physical data of a scene containing the target;
conveying the shelled portions to a delivery point, based on the mission parameters and the physical data; and
calculating a ballistic trajectory based on the selected shelled portions parameters, for ballistically delivering the shelled portions towards the target,
wherein the shelled portions comprise fluids or granular substances covered by a flexible shells that provide the shelled portions a ballistic coefficient that is significantly higher than a ballistic coefficient of similar portions without the shells, and
wherein the shelled portion are selected to have a weight that renders them non-harmful upon impact with humans or animals.

30. The method according to claim 29, wherein the weight of the shells is approximately between 100 and 300 grams.

31. The method according to claim 29, further comprising obtaining mission parameters containing at least one of: a required type of effective ingredients, a required density of the effective substance at the target, and a desired distribution footprint of the shelled portions at the target.

32. The method according to claim 29, further comprising targeting the delivering of the shelled portions towards the target using optical targeting means that predicts impact area for the shelled portions at any given time.

33. The method according to claim 29, wherein the selecting and the ballistically delivering are carried out in view of avoiding harmful impact of the shelled portions in a case of human or object presence near or at the target.

34. The method according to claim 29, wherein the shelled portions comprise a shell that is made of bio-degradable or compostable materials.

35. The method according to claim 29, wherein the shelled portions comprise a shell that is configured to break prior to impact with the target so as to release at least some of the effective ingredients prior to the impact with the target.

36. The method according to claim 29, wherein the shelled portions contain two or more substances that are arranged to interact upon hitting the target or prior to the hitting due to rotational forces.

37. The method according to claim 29, wherein the shelled portions contain two or more substances, and wherein one of the two or more substances is arranged to generate a gaseous substance or foam upon impact at target or prior to the impact.

38. The method according to claim 29, wherein the ballistically delivering is carried out by an aerial vehicle.

39. The method according to claim 38, wherein the selecting is carried out during flight of the aerial vehicle.

40. The method according to claim 38, wherein the conveying is preceded by loading the aerial vehicles with the selected shelled portions using a dispenser that is arranged to fit into a plurality of types of aerial vehicles.

41. The method according to claim 29, wherein the ballistically delivering of the shelled portions is carried out using a dispenser that comprises a conveyer and a container that contains the shelled portions and wherein the dispenser is configured to accelerate the container along the conveyer and then bring the container to a complete and sudden stop so as to force the shelled portions ballistically out of the container.

42. The method according to claim 29, wherein each one of the shelled portions includes holes going through the shell and tilted fins located at one end of the shell designed such that during the ballistic delivery, the shelled portions rotate around their longitudinal axis at an increasing angular speed which results in the fluid exiting the shelled portion.

43. A system for delivering over the air, shelled portions of fluids or granular substances containing effective ingredients to a target, the system comprising:
means for selecting a type and a size of the shelled portions, based on the mission parameters and the physical data;
means for conveying the shelled portions to a delivery point based on the mission parameters and the physical data; and
means for calculating a ballistic trajectory based on the selected shelled portions parameters, for ballistically delivering the shelled portions towards the target,
wherein the shelled portions comprise fluids or granular substances covered by flexible shells that provide the shelled portions a ballistic coefficient that is significantly higher than a ballistic coefficient of similar portions without the shells,
wherein the shelled portion are selected to have a weight that renders them non-harmful upon impact with humans or animals.

44. The system according to claim 43, wherein the weight of the shells is approximately between 100 and 300 grams.

45. The system according to claim 43, further comprising means for obtaining mission parameters containing at least one of: a required type of effective ingredients, the required density of the effective ingredients at the target, and a desired distribution footprint of the shelled portions at the target.

46. The system according to claim 43, further comprising means for optical targeting the delivering of the shelled portions towards the target so that the impact area for the shelled portions at any given time is predicted.

47. The system according to claim 43, wherein the shelled portions comprise a shell that is made of a bio-degradable or a compostable material.

48. The system according to claim 43, wherein the shelled portions comprise a shell that is configured to break or open prior to impact with the target so as to release at least some of the effective ingredients prior to the impact with the target.

49. The system according to claim 43, wherein the shelled portions contain two or more substances that are arranged to interact upon hitting the target or prior to the hitting due to rotational forces.

50. The system according to claim 43, wherein the shelled portions contain two or more substances, wherein one of the two or more substances is arranged to generate a gaseous substance or foam upon impact at the target or prior to the impact.

51. The system according to claim 43, wherein the means for conveying and the means of delivering are implemented by an aerial vehicle.

52. The system according to claim 51, wherein the means for selection is located on the aerial vehicle and wherein the selecting is carried out during flight.

53. The system according to claim 43, further comprising a dispenser that comprises a plurality of shelled portions of various sizes and types, wherein the dispenser is loaded on the aerial vehicle.

54. The system according to claim 53, wherein the dispenser is arranged to fit a plurality of types of aerial vehicles.

55. The system according to claim 43, further comprising a dispenser that comprises a conveyer and a container which contains the shelled portions and wherein the dispenser is configure to accelerate the container along the conveyer and then bring the container to a complete and sudden stop so as to force the shelled portions ballistically out of the container.

56. The system according to claim 43, wherein each one of the shelled portions includes holes going through the shell and tilted fins located at one end of the shell designed such that during the ballistic delivery, the shelled portions rotate around their longitudinal axis at an increasing angular speed which results in the fluid exiting the shelled portion.
